(19) United States
(12) Patent Application Publication
(10) Pub. No.: US 2008/0122911 A1
(43) Pub. Date: May 29, 2008

(54) Drop ejection apparatuses

(76) Inventors: Scott G. Page, Alstead, NH (US); Alan H. Boyer, Spofford, NH (US); Benjamin J. Brown, Keene, NH (US)

Correspondence Address: FISH & RICHARDSON PC, P.O. BOX 1022, MINNEAPOLIS, MN, 55440-1022, US

(21) Appl. No.: 11/604,964

(22) Filed: Nov. 28, 2006

(51) Int. Cl. B41J 2/19

(52) U.S. Cl. 347/92

(57) ABSTRACT

Material-handling systems are described that maximize the stability of materials, such as inks or clear overcoat materials. Some of the material handling systems oxygenate the material as it moves through the material-handling systems, reducing premature polymerization of the material and/or providing a stable viscosity.

### TECHNICAL FIELD

This invention relates to drop ejection apparatuses, and to related apparatuses and methods.

### BACKGROUND

Some radiation-curable, e.g., UV-curable, jetting materials are liquid at room temperature. To ensure correct jetting viscosity, these liquid radiation-curable materials, e.g., inks and clear overcoats, are often jetted above room temperature, e.g., 35° C. or more, e.g., 45° C. Such materials can be jetted onto substantially non-porous substrates, e.g., plastic pen barrels or circuit boards, or porous substrates, e.g., paper. When such liquid radiation-curable materials are jetted onto a substrate, e.g., paper or plastic, to form an image, phenomena such as bleed-through, pinhole wetting and fisheyes due to the wetting characteristics of the liquid can result in inadequate coverage and overall poor print quality. One solution that is often used to reduce wicking is to treat the substrate to make it less porous. However, some liquid radiation-curable materials do not perform well with such treatments. Another solution to minimizing wicking and bleed-through is to rapidly surface cure the liquid radiation-curable materials, but often this does not completely eliminate wicking and bleed-through, and can require cumbersome and expensive equipment.

“Hybrid-F” radiation-curable jetting materials, i.e., those that polymerize by radical and/or cationic mechanisms to give polymer networks, are often described as “semi-solid materials,” and can be substantially more viscous at room temperature than at jetting temperature. Hybrid-F materials are available from Aellora™, e.g., under the tradename VistaSpec™ HB. Typically, these materials are jetted at elevated temperatures, e.g., above 60° C. or above 65° C., to lower material viscosity to an appropriate jetting viscosity. After jetting hybrid-F ink, e.g., through a piezoelectric drop-on-demand printhead, material viscosity rapidly increases as the material cools on contact with the substrate. Once cooled to about room temperature, the hybrid-F material does not flow without shear, allowing “wet-on-wet” printing without intermediate curing stages. Since the hybrid-F material does not substantially flow at room temperature, wetting defects can be reduced, often reducing or eliminating the need for substrate surface treatments.

Liquid and hybrid-F radiation-curable materials typically contain one or more inhibitors, e.g., hydroquinone (HQ), hydroquinone monomethyl ether (MEHQ) or mixtures thereof, which help to stabilize the material, e.g., inhibit premature polymerization of the material. Premature polymerization is problematic since it can clog small and delicate flow pathways and/or jetting nozzles within a print engine. Oxygen often works in combination with inhibitors to reduce instabilities, e.g., premature thermal polymerization. In such systems, oxygen is used up in chemical reactions that occur in the material, e.g., during conveyance of the material from a supply to a printhead that jets the material.

### SUMMARY

Generally, material-handling systems are described that maximize the stability of a material such as an ink or a clear overcoat material. Some of the material handling systems oxygenate the material in the material-handling systems, e.g., as it moves through the material handling systems or as the material sits stationary in the material handling systems, reducing premature polymerization of the material. For example, apparatuses for printing on a substrate are described in which a jetting material is oxygenated during conveyance of the jetting material from a supply to a printhead. For example, an apparatus can include a printing module configured to print a material that includes a radiation-curable material and a material supply module that includes a conduit connecting the print module and a material supply. At least a portion of the printing module and/or the material supply module, e.g., the conduit, has a gas permeable device that is in fluid communication with the jetting material. The gas permeable device has a first side configured to contact the ink and a second side opposite the first side configured to be maintained at a pressure greater than the first side such that gas diffuses from the second side to the first side. Other apparatuses described herein can, e.g., include a device configured to inject gas bubbles into the material.

In one aspect, the invention features drop ejecting apparatuses that include a jetting module configured to jet a material that includes a radiation-curable material, a material supply module connected to the jetting module by a conduit and a gas permeable device attached to a wall of the conduit. The device includes a partition and a gas-supply region; the partition includes a non-wetting layer adjacent the gas-supply region and a wetting layer opposite the non-wetting layer. One or more passageways extend through the wetting and non-wetting layers.

Embodiments may include one or more of the following features. A thickness of the wetting layer and/or non-wetting layer is from about 0.5 micron to about 25 micron. The passageways are circular in transverse cross-section, e.g., having a diameter of from about 0.25 micron to about 5 micron. The non-wetting layer includes a fluoropolymer, such as poly(tetrafluoroethylene), PTFE. The wetting layer includes an oxide, such as a silicon oxide, e.g., silicon dioxide. The gas-supply region contains air or oxygen-enriched air (relative to air at sea level on earth). The gas-supply region is maintained at a pressure of from about 2 mm Hg to about 25 mm Hg higher than a pressure inside the conduit.

In another aspect, the invention features methods of jetting materials that include providing a drop ejector that includes a jetting module configured to jet a material that includes a radiation-curable material, a material supply module connected to the jetting module by a conduit, and a gas permeable device attached to a wall of the conduit that includes a partition and a gas-delivery region. The partition includes a non-wetting layer adjacent the gas-delivery region and a wetting layer opposite the non-wetting layer, and one or more passageways extending through the wetting and non-wetting layers. The material that includes the radiation-curable material is conveyed through the conduit in such a manner that the material contacts the wetting layer of the gas permeable device; and gas is delivered to the gas-supply region.

In another aspect, the invention features drop ejecting apparatuses that include a jetting module configured to jet a material that includes a radiation-curable material and a material supply module that includes a conduit connecting the jetting module and a supply. The conduit includes a material having an oxygen permeability coefficient of greater than 20×10⁻¹¹ cm³·cm/cm²·s·cm Hg at standard temperature and pressure.

Embodiments may have one or more of the following features. The conduit includes a crosslinked material, such as a cross-linked polysiloxane. The oxygen permeability coefficient is greater than 1000×10⁻¹¹ cm³·cm/cm²·s·cm Hg, e.g., greater than 25000×10⁻¹¹ cm³·cm/cm²·s·cm Hg.

In another aspect, the invention features methods of jetting materials that include providing a drop ejector that includes a jetting module configured to jet a material that includes a radiation-curable material and a material supply module connected to the jetting module by a conduit. The conduit includes a material having an oxygen permeability coefficient of greater than 20×10⁻¹¹ cm³·cm/cm²·s·cmHg at standard temperature and pressure. The material that includes the radiation-curable material is conveyed through the conduit.

In another aspect, the invention features, methods of jetting that include providing a drop ejector that includes a jetting module configured to jet a material that includes a radiation-curable material and a material supply module housing the material and connected to the jetting module by a conduit; and delivering gas bubbles to the material.

Embodiments may include one or more of the following features. The gas bubbles are delivered from a porous bubbler, such as one that includes sintered metal particles. The gas bubbles delivered have a diameter of less than about 100 micron, e.g., less than about 10 micron or less than about 1 micron.

In another aspect, the invention features packages for holding a jetting material that include a hollow first container housing material including a radiation-curable material, an operable seal disposed on the first container and a hollow second container disposed inside the sealed hollow first container, the hollow second container having an aperture defined in a wall of the second container.

Embodiments may include any one or more of the following features. Each aperture is circular in transverse cross-section, e.g., each having a diameter of between about 0.001 inch to about 0.025 inch. The hollow first container is sealed with air or oxygen-enriched air (relative to sea level air on earth). A pressure in an airspace of the first container is greater than 12 psi (gauge), e.g., greater than 20 psi, 30 psi, 50 psi or even greater than 100 psi.

Embodiments may have one or more of the following advantages. Generally, the material, such as ink, in the material-handling systems has enhanced stability, e.g., a reduced tendency to polymerize. For example, the ink handling systems have a reduced tendency to thermally polymerize ink flowing through the ink flow pathways, which can result in a system having enhanced ink flow and jetting performance. Such ink handling systems have a reduced tendency for ink flow pathway blockage, nozzle clogging, and/or valve blockage. This in turn reduces cleaning downtime and improves printing efficiency. Keeping the often small and delicate flow paths and/or nozzles clear of containments allow materials to flow through the flow paths with reduced resistance. Lower resistance to flow enables, e.g., a more rapid refilling of the pumping chamber. For example, rapidly refilling the pumping chamber can translate into an ability to eject drops at a higher frequency, e.g., 10 kHz, 25 kHz, 50 kHz or higher, e.g., 75 kHz. Higher frequency printing can improve the resolution of ejected drops by increasing the rate of drop ejection, reducing size of the ejected drops, and enhancing velocity uniformity of the ejected drops. In addition, keeping nozzles and/or flow paths clear of polymerized ink can reduce ejection errors, such as mis-fires or trajectory errors, and thereby improve overall print quality.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference herein in their entirety for all that they contain. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a perspective schematic view of a printing apparatus including a printing module and ink supply module.

FIGS. 1A and 1B are perspective front and back views of a printhead, respectively.

FIG. 2 is an enlarged perspective view of a portion of a printhead.

FIG. 3 is a cross-sectional view taken along line 3-3 of FIG. 1.

FIG. 4 is a perspective schematic view of a printing apparatus that includes a conduit having a relatively high oxygen gas permeability.

FIG. 5 is a schematic side view of a porous bubbler delivering bubbles of a gas to a jetting material.

FIG. 5A is a highly enlarged view of region 5A of FIG. 5.

FIGS. 6A and 6B are perspective see-through views of a package for housing a jetting material; FIG. 6A being the package in a sealed state and FIG. 6B being the package in an open state.

### DETAILED DESCRIPTION

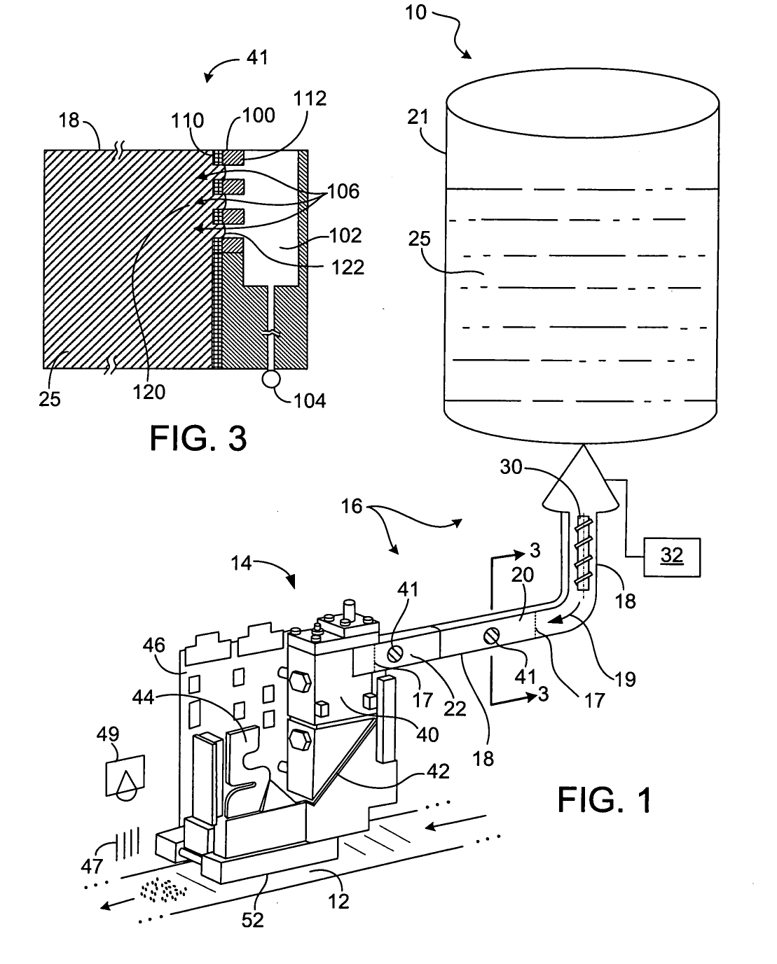

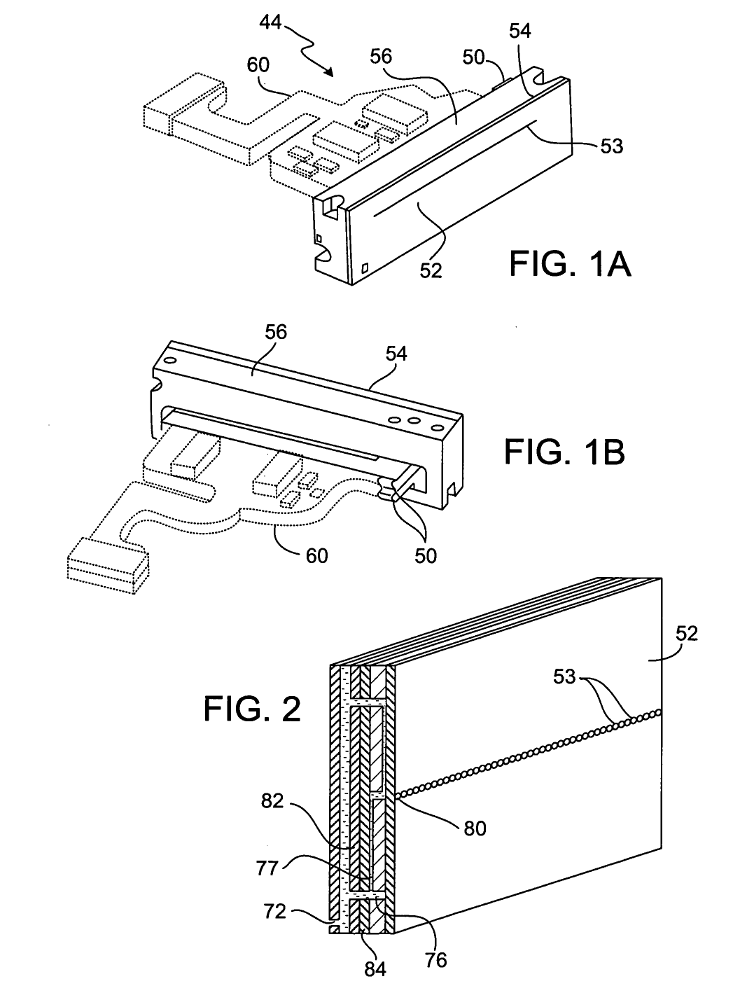

Referring FIG. 1, an apparatus 10 for printing on a substrate 12 includes a material supply module 16 and a printing module 14 which is configured to jet a material 25 that includes a radiation-curable material. Material supply module 16 has a pathway 18 from a material supply 21 to the printing module 14. The pathway 18 includes a first portion 20 that is configured to maintain the jetting material below a first temperature T₁, and a second portion 22 downstream of first portion 20 that is configured to heat the jetting material above first temperature T₁, e.g., at least about 25° C. above first temperature T₁, as it is conveyed (indicated by arrow 19) through second portion 22.

Pathway 18 can be made gas permeable, allowing for oxygenation of jetting material 25. Oxygenation replaces any oxygen lost, e.g., due to chemical reactions, in the jetting material during its conveyance from supply 21 to printing module 14. Maintaining or enhancing an oxygen level of the jetting material from jetting material supply to printing module enhances the performance of the inhibition package added to the jetting material. In particular implementations, pathway 18 can include one or more (e.g., 2, 4, 6, 8, 10 or even 20) semi-permeable devices 41 that are disposed along the length of pathway 18. The semi-permeable nature of the device 41 prevents jetting material from escaping from the flow pathway 18, while allowing oxygen to pass through. Oxygen works synergistically, and in combination with, inhibitors to reduce instabilities, e.g., premature thermal polymerization of jetting material components, e.g., in flow pathway 18. In addition, flow pathway 18 can include filters 17, e.g., screen-type filters or sintered-type filters. Such filters can remove dust, debris and gels from the jetting material that can block ink flow pathways, nozzles, valves and/or filters, leading to a reduction in print quality. Such filters can also be located at other suitable locations along the ink flow pathways.

In the embodiment of FIG. 1, jetting material 25 is conveyed through supply module 16 utilizing an auger 30. Controller 32 manages the direction of rotation and the rotational speed of auger 30. After exiting portion 22 of pathway 18, the jetting material is delivered to a reservoir 40 in printing module 14, where the temperature of the jetting material is maintained at a suitable jetting temperature, e.g., greater than 75° C. In some instances, the heating of the jetting material in the second portion 22 increases jetting material temperature exiting the second portion to a temperature that is within 15° C. of jetting material residing in the reservoir 40. This minimizes the possibility that the ink in reservoir 40 is thermally shocked by the ink entering from the ink supply module 16. The jetting material then travels along flow path 42 to printhead 44. Controller 46 controls the jetting of material onto substrate 12, which is traveling below the printhead (as indicated by arrow). Drop ejection is controlled by pressurizing the jetting material with an actuator, such as, e.g., a piezoelectric actuator, a thermal bubble jet generator, or an electrostatically deflected element. Typically, printhead 44 has an array of paths with corresponding nozzle openings and associated actuators, such that drop ejection from each nozzle opening can be independently controlled. U.S. Pat. No. 5,265,315 describes a printhead that has a semiconductor body and a piezoelectric actuator. Piezoelectric inkjet printheads are described in U.S. Pat. Nos. 4,825,227, 4,937,598, 5,659,346, 5,757,391, and in U.S. Patent Application No. 2004/0004649, now issued as U.S. Pat. No. 7,052,117. Jetting material such as ink on substrate 12, e.g., in the form of text or graphics, is cured with a radiation source 47, e.g., ultra-violet light from a UV lamp 49, or e-beam radiation. If UV radiation is used to cure the radiation-curable material, a wavelength of the light that cures the radiation-curable material is between about 200 nm and about 400 nm, e.g., a typical output from a medium pressure, metal-doped lamp, e.g., an iron-mercury lamp.

Referring to FIGS. 1, 1A, 1B and 2, piezoelectric printhead 44 includes jetting modules 50 and an orifice plate 52 with an array of orifice openings 53. The orifice plate 52 is mounted on a manifold 54, attached to a collar 56. The inkjet printhead 44 is controlled by electrical signals conveyed by flexprint elements 60 that are in electrical communication with controller 46 of print module 14.

Referring particularly to FIG. 2, in operation, jetting material flows from a reservoir (not shown) into a passage 72. The jetting material is then conveyed through passage 76 to a pressure chamber 77 from which it is ejected on demand through an orifice passageway 80 and a corresponding orifice 53 in the orifice plate 52 in response to selective actuation of an adjacent portion 82 of a piezoelectric actuator plate 84. Commercial inkjet printheads are available from Dimatix, Inc. (Spectra Printing Division), Hanover, N.H.

Referring again to FIG. 1 and now to FIG. 3, semi-permeable device 41 includes a partition 100, and a gas-delivery region 102, which in operation encloses a gas, e.g., air or oxygen-enriched air, under pressure. During operation, gas is delivered to gas-delivery region 102 via a gas source 104. Partition 100 includes passageways 106 between the pathway 18 and pressure region 102. Partition 100 also includes a wetting layer 110 adjacent the pathway 12 and a non-wetting layer 112 adjacent the gas-delivery region 102. Jetting material in region 120 along flow pathway 18 comes into contact with wetting layer 110 of partition 100, and absorbs oxygen delivered through passageways 106 that communicate with gas-delivery region 102 (flow indicated by arrows). To facilitate flow of gas from the gas-delivery region, the gas-delivery region is typically maintained at a higher pressure (e.g., about 5 mm Hg to about 50 mm Hg, about 2 mm Hg to about 25 mm Hg or about 5 mm Hg to about 10 mm Hg) than pressure in flow pathway 18. In particular, jetting material 25 in region 120 contacts partition 100 and enters passageways 106, forming a meniscus 122 at the interface between the wetting and non-wetting layers 110, 112. The jetting material in region 120 is exposed, through the passageways 106, to the gas-delivery region 102, absorbing gas as it passes. The size of the passageways 106, magnitude of the gas pressure and the materials of the partition layer 100 are selected such that fluid is drawn into the passageways 106, but not drawn beyond the passageways 106 and into the gas-delivery region 102.

In some embodiments, the passageways 106 are circular in transverse cross-section, having a radius of about 5 micron or less, e.g., between about 5 micron and about 0.1 micron, e.g., between about 1.0 micron and 0.5 micron. A partition layer having an exposed surface area of several square centimeters typically includes thousands of passageways. For example, between about 10% and about 90% (e.g., 20% to 80%, 30% to 70%, 40% to 50%) of the partition can be made up of open passageways.

In some embodiments, the wetting layer 110 has a surface energy equal to or greater than 40 dynes/cm, as determined according to the dynes test. In general, the dynes test is used to determine the surface energy of a solid surface through the application of a series of fluids that each have a different surface energy level (e.g., 30 dynes/cm to 70 dynes/cm in +1 dynes/cm increments.) A drop of one of the fluids in the series is applied to the solid surface. If the drop wets the surface, then a drop of the next higher surface energy level fluid is applied to the solid surface. This process is continued until the drop of fluid does not wet the solid surface (i.e., cohesive forces are stronger than adhesive forces). The surface energy of the solid surface is determined to be the same as the surface energy of the first fluid in the series that does not wet the solid surface. Equipment and instructions for performing the dynes test are available from Diversified Enterprises, Claremont, N.H. An example of a suitable material for the wetting layer 110 is an oxide layer, such as silicon dioxide. In some embodiments, the wetting layer has a thickness of about 25 micron or less, e.g., 1 micron or less. In some embodiments, the non-wetting layer 112 has a surface energy of about 40 dynes/cm or less, such as 25 dynes/cm or less. An example of a suitable material for the non-wetting layer 112 is a polymer, such as a fluoropolymer, e.g., poly(tetrafluoroethylene) available under the tradename TEFLON®. In some embodiments, the non-wetting layer 112 has a thickness of about 2 micron, e.g. about 1 micron or about 0.5 micron. A deaerator having a wetting and a non-wetting layer is described in Hoisington et al., in U.S. Patent Application No. 2005/0185030, now issued as U.S. Pat. No. 7,052,122.

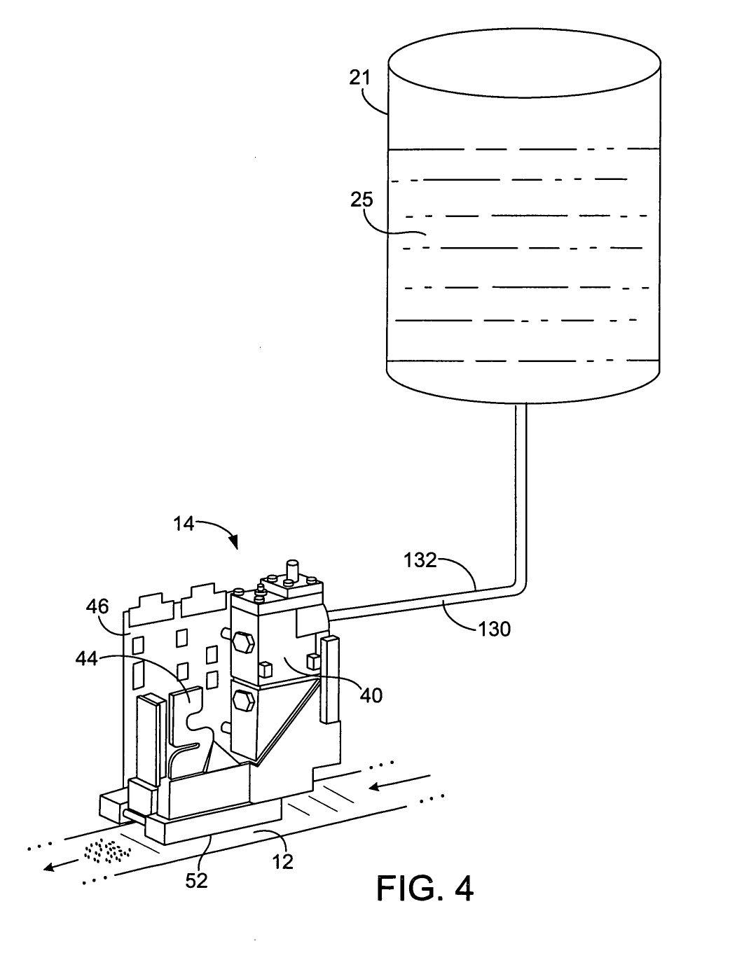

Referring now to the embodiment shown in FIG. 4, in some embodiments, a jetting material is conveyed from supply 21 to printing module 14 through a conduit 130 that includes a wall 132 having an oxygen permeability coefficient of greater than 20×10⁻¹¹ cm³·cm/cm²·s·cm Hg, e.g., greater than 40×10⁻¹¹, 100×10⁻¹¹, 200×10⁻¹¹, 500×10⁻¹¹, 1000×10⁻¹¹, 4000×10⁻¹¹, 25000×10⁻¹¹, or even greater than 40000×10⁻¹¹ cm³·cm/cm²·s·cm Hg at standard temperature and pressure (STP).

Suitable conduit materials generally have good chemical resistance and a relatively high oxygen permeability coefficient. Materials include, e.g., crosslinked polyvinylchloride, crosslinked chlorinated polyvinylchloride, crosslinked polyurethane, and crosslinked silicone.

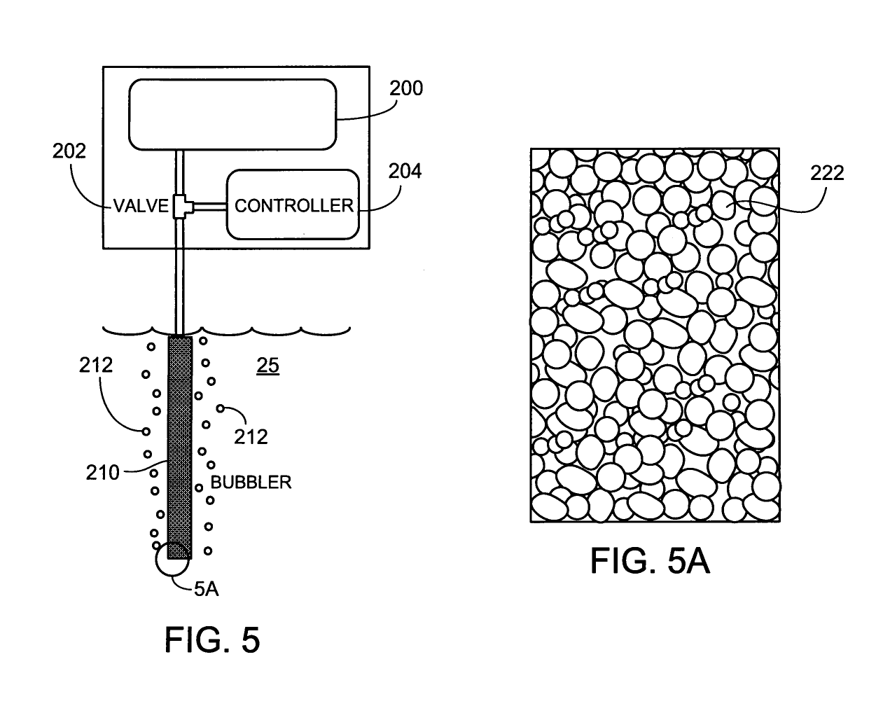

Referring now to the embodiment shown in FIGS. 5 and 5A, the jetting material can be saturated or even super-saturated with a gas such as air or oxygen-enriched air by delivering bubbles of a desired gas to the jetting material. In the particular embodiment illustrated in FIGS. 5 and 5A, the bubbles are delivered to the jetting material from a source of pressurized gas 200, which is controlled by actuating a valve 202 using a controller 204. When valve 202 has been actuated to the “on” position, gas enters a porous bubbler 210, which converts the bulk gas to small bubbles 212 of the gas. To increase efficiency of solubilizing the gas into the jetting material, bubbles smaller than 1000 micron are generally preferred, e.g., less than 500 micron, less than 250 micron, less than 100 micron, less than 50 micron, less than 25 micron, less than 10 micron, less than 1 micron, or even less than 0.5 micron.

The bubbler can be made by sintering metal particles 222, e.g., having diameters between about 0.1 micron and 10 micron, to form a porous material though which a gas may flow. Bubblers are available from Mott Corporation, and are described in Kerfoot, U.S. Pat. No. 6,827,861 and Mitani et al., Ozone: Science and Engineering, 27, 45-51 (2005).

Gas bubbles can be delivered at any point or multiple points along the flow pathway from ink supply to jetting module.

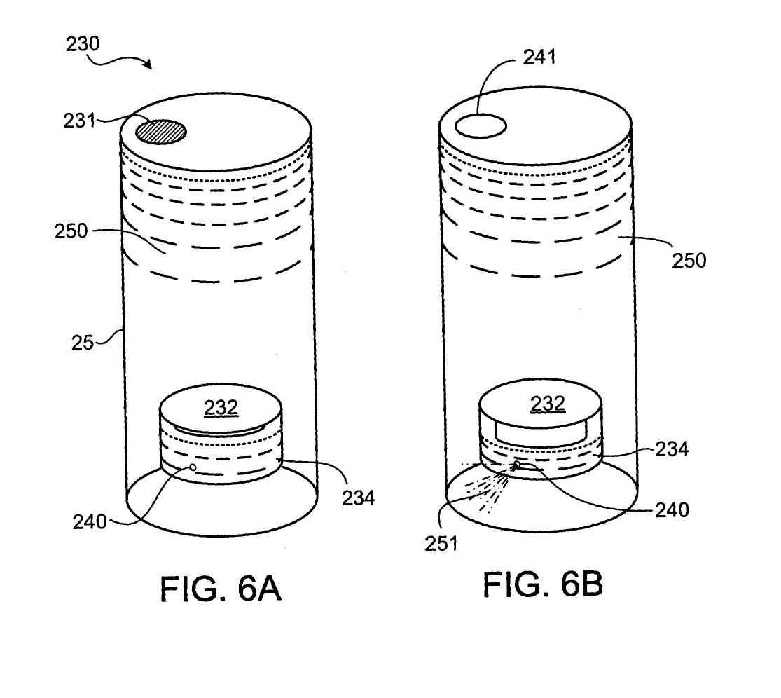

Referring now to the embodiment shown in FIGS. 6A and 6B, a pressurized jetting material supply drum 230 is sealed via bung 231. Prior to sealing and pressurizing the drum 230 with a desired gas, e.g., air or oxygen-enriched air, a hollow cylinder 232 that is closed except for an aperture 240 defined in a wall 234 of the hollow cylinder 232 is placed into the supply drum, followed by a desired jetting material 25. Prior to use, the bung 231 is removed, exposing a relatively large aperture 241, e.g., a circular aperture having a diameter of about 1 to about 5 inch. The pressure in the airspace 250 is rapidly equalized with atmospheric pressure. However, in order for the pressure to equalize in the hollow cylinder 232, gas has to be transferred through relatively small aperture 240, generating a stream of bubbles 251 exiting aperture 240. A beverage employing this principle has been described by Forage et al., U.S. Pat. No. 4,832,968.

In some embodiments, the supply drum 230 is pressurized to a pressure of 12 psi (gauge), e.g., 20 psi, 30 psi, 50 psi or even 100 psi. In some embodiments, the aperture 241 is circular in cross-section and has a diameter of less than 0.030 inch, e.g., less than 0.025 inch, less than 0.020 inch, less than 0.010 inch, less than 0.005 inch, less than 0.001 inch or even less than 0.0005 inch.

Generally, suitable jetting materials include clear overcoats, colorants, polymerizable materials, e.g., monomers and/or oligomers, and photoinitiating systems. The polymerizable materials can be cross-linkable.

Colorants in the jetting material can include pigments, dyes, or combinations thereof. In some implementations, inks include less than about 10 percent by weight colorant, e.g., less than 7.5 percent, less than 5 percent, less than 2.5 percent or less than 0.1 percent.

The pigment can be black, cyan, magenta, yellow, red, blue, green, brown, or a mixture these colors. Examples of suitable pigments include carbon black, graphite and titanium dioxide. Additional examples are disclosed in, e.g., U.S. Pat. No. 5,389,133. Alternatively or in addition to the pigment, the inks can contain a dye. Suitable dyes include, e.g., Orasol Pink 5BLG, Black RLI, Blue 2GLN, Red G, Yellow 2GLN, Blue GN, Blue BLN, Black CN, and Brown CR, each being available from Ciba-Geigy. Additional suitable dyes include Morfast Blue 100, Red 101, Red 104, Yellow 102, Black 101, and Black 108, each being available from Morton Chemical Company. Other examples include, e.g., those disclosed in U.S. Pat. No. 5,389,133. Mixtures of colorants may be employed.

Generally, the jetting materials contain a polymerizable material, e.g., one or more polymerizable monomers. The polymerizable monomers can be mono-functional, di-functional, tri-functional or higher functional, e.g., penta-functional. The mono-, di- and tri-functional monomers have, respectively, one, two, or three functional groups, e.g., unsaturated carbon-carbon groups, which are polymerizable by irradiating in the presence of photoinitiators. In some implementations, the jetting materials include at least about 40 percent, e.g., at least about 50 percent, at least about 60 percent, or at least about 80 percent by weight polymerizable material. Mixtures of polymerizable materials can be utilized, e.g., a mixture containing mono-functional and tri-functional monomers. The polymerizable material can optionally include diluents.

Examples of mono-functional monomers include long chain aliphatic acrylates or methacrylates, e.g., lauryl acrylate or stearyl acrylate, and acrylates of alkoxylated alcohols, e.g., 2-(2-ethoxyethoxy)-ethyl acrylate. The di-functional material can be, e.g., a diacrylate of a glycol or a polyglycol. Examples of the diacrylates include the diarylates of diethylene glycol, hexanediol, dipropylene glycol, tripropylene glycol, cyclohexane dimethanol (Sartomer CD406), and polyethylene glycols. Examples of tri- or higher functional materials include tris(2-hydroxyethyl)-isocyanurate triacrylate (Sartomer SR386), dipentaerythritol pentaacrylate (Sartomer SR399), and alkoxylated acrylates, e.g., ethoxylated trimethylolpropane triacrylates (Sartomer SR454), propoxylated glyceryl triacrylate, and propoxylated pentaerythritol tetraacrylate. The jetting materials may also contain one or more oligomers or polymers, e.g., multi-functional oligomers or polymers.

In some instances, the viscosity of the jetting material is between about 1 centipoise and about 50 centipoise, e.g., from about 5 centipoise to about 45 centipoise, or from about 7 centipoise to about 35 centipoise, at a temperature ranging from about 20° C. to about 150° C.

A photoinitiating system, e.g., a blend, in the jetting materials is capable of initiating polymerization reactions upon irradiation, e.g., ultraviolet light irradiation. The photoinitiating system can include, e.g., an aromatic ketone photoinitiator, an amine synergist, an alpha-cleavage type photoinitiator, and/or a photosensitizer. Each component is fully soluble in the monomers and/or diluents described above. Specific examples of the aromatic ketones include, e.g., 4-phenylbenzophenone, dimethyl benzophenone, trimethyl benzophenone (Esacure TZT), and methyl O-benzoyl benzoate.

An amine synergist can be utilized. For example, the amine synergist can be a tertiary amine. Specific examples of the amine synergists include, e.g., 2-(dimethylamino)-ethyl benzoate, ethyl 4-(dimethylamino) benzoate, and amine functional acrylate synergists, e.g., Sartomer CN384, CN373.

An alpha-cleavage type photoinitiator can be an aliphatic or aromatic ketone. Examples of the alpha-cleavage type photoinitiators include, e.g., 2,2-dimethoxy-2-phenyl acetophenone, 2,4,6-trimethylbenzoyl-diphenylphosphine oxide, and 2-methyl-1-[4-(methylthio)phenyl-2-morpholino propan-1-one (Irgacure 907).

A photosensitizer can be a substance that either increases the rate of a photoinitiated polymerization reaction or shifts the wavelength at which the polymerization reaction occurs. Examples of photosensitizers include, e.g., isopropylthioxanthone (ITX), diethylthioxanthone and 2-chlorothioxanthone.

The jetting materials may contain an adjuvant such as a vehicle (e.g., a wax or resin), a stabilizer, an oil, a flexibilizer, or a plasticizer. The stabilizer can, e.g., inhibit oxidation of the ink. The oil, flexibilizer, and plasticizer can reduce the viscosity of the jetting material.

Examples of waxes include, e.g., stearic acid, succinic acid, beeswax, candelilla wax, carnauba wax, alkylene oxide adducts of alkyl alcohols, phosphate esters of alkyl alcohols, alpha alkyl omega hydroxy poly(oxyethylene), allyl nonanoate, allyl octanoate, allyl sorbate, allyl tiglate, bran wax, paraffin wax, microcrystalline wax, synthetic paraffin wax, petroleum wax, cocoa butter, diacetyl tartaric acid esters of mono and diglycerides, alpha butyl omega hydroxypoly(oxyethylene)poly(oxypropylene), calcium pantothenate, fatty acids, organic esters of fatty acids, amides of fatty acids (e.g., stearamide, stearyl stearamide, erucyl stearamide (e.g., Kemamide S-221 from Crompton-Knowles/Witco), calcium salts of fatty acids, mono & diesters of fatty acids, lanolin, polyhydric alcohol diesters, oleic acids, palmitic acid, d-pantothenamide, polyethylene glycol (400) dioleate, polyethylene glycol (MW 200-9,500), polyethylene (MW 200-21,000); oxidized polyethylene; polyglycerol esters of fatty acids, polyglyceryl phthalate ester of coconut oil fatty acids, shellac wax, hydroxylated soybean oil fatty acids, stearyl alcohol, and tallow and its derivatives.

Examples of resins include, e.g., acacia (gum arabic), gum ghatti, guar gum, locust (carob) bean gum, karaya gum (sterculia gum), gum tragacanth, chicle, highly stabilized rosin ester, tall oil, manila copais, corn gluten, coumarone-indene resins, crown gum, damar gum, dimethylstyrene, ethylene oxide polymers, ethylene oxide/propylene oxide copolymer, heptyl paraben, cellulose resins, e.g., methyl and hydroxypropyl; hydroxypropyl methylcellulose resins, isobutylene-isoprene copolymer, polyacrylamide, functionalized or modified polyacrylamide resin, polyisobutylene, polymaleic acid, polyvinyl acetate, polyvinyl alcohol, polyvinyl pyrrolidone, rosin, pentaerythritol ester, purified shellac, styrene terpolymers, styrene copolymers, terpene resins, turpentine gum, zanthan gum and zein.

Examples of stabilizers, oils, flexibilizers and plasticizers include, e.g., methylether hydroquinone (MEHQ), hydroquinone (HQ), butylated hydroxyanisole (BHA), butylated hydroxytoluene (BHT), propyl gallate, tert-butyl hydroquinone (TBHQ), ethylenediaminetetraacetic acid (EDTA), methyl paraben, propyl paraben, benzoic acid, glycerin, lecithin and modified lecithins, agar-agar, dextrin, diacetyl, enzyme modified fats, glucono delta-lactone, carrot oil, pectins, propylene glycol, peanut oil, sorbitol, brominated vegetable oil, polyoxyethylene 60 sorbitan monostearate, olestra, castor oil; 1,3-butylene glycol, coconut oil and its derivatives, corn oil, substituted benzoates, substituted butyrates, substituted citrates, substituted formats, substituted hexanoates, substituted isovalerates, substituted lactates, substituted propionates, substituted isobutyrates, substituted octanoates, substituted palmitates, substituted myristates, substituted oleates, substituted stearates, distearates and tristearates, substituted gluconates, substituted undecanoates, substituted succinates, substituted gallates, substituted phenylacetates, substituted cinnamates, substituted 2-methylbutyrates, substituted tiglates, paraffinic petroleum hydrocarbons, glycerin, mono- and diglycerides and their derivatives, polysorbates 20, 60, 65, 80, propylene glycol mono- and diesters of fats and fatty acids, epoxidized soybean oil and hydrogenated soybean oil.

Additional jetting materials are described by Woudenberg in U.S. Patent Application No. 2004/0132862, now issued as U.S. Pat. No. 6,896,937.

### OTHER EMBODIMENTS

While certain embodiments have been described, other embodiments are possible. While the embodiment of FIG. 1 utilizes a single jetting material, more than one jetting material can be conveyed. For example, two, three, four, five, six, seven or more, e.g., ten jetting materials can be conveyed. Each jetting material may be a different color, for example.

While oxygen or oxygen-enriched air has been used in some embodiments, other gases, e.g., inert gases such as nitrogen or argon, may be utilized.

Any of the systems described herein can be combined. For example, a hybrid system can be produced by combining the bubbler of FIG. 5 with the device of FIG. 3 and/or the conduit of FIG. 4.

Other embodiments are within the scope of the following claims.

What we claim is:

1. A drop ejecting apparatus, comprising:
a jetting module configured to jet a material comprising a radiation-curable material;
a material supply module connected to the jetting module by a conduit; and
a gas permeable device attached to a wall of the conduit, wherein the device includes a partition and a gas-supply region, wherein the partition includes a non-wetting layer adjacent the gas-supply region and a wetting layer opposite the non-wetting layer, and one or more passageways extending through the wetting and non-wetting layers.

2. The drop ejecting apparatus of claim 1, wherein a thickness of the wetting layer is from about 0.5 micron to about 25 micron.

3. The drop ejecting apparatus of claim 1, wherein a thickness of the non-wetting layer is from about 0.5 micron to about 25 micron.

4. The drop ejecting apparatus of claim 1, wherein the passageways are circular in transverse cross-section, having a diameter of from about 0.25 micron to about 5 micron.

5. The drop ejecting apparatus of claim 1, wherein non-wetting layer comprises a fluoropolymer.

6. The drop ejection apparatus of claim 5, wherein the fluoropolymer comprises poly(tetrafluoroethylene).

7. The drop ejection apparatus of claim 1, wherein the wetting layer comprises an oxide.

8. The drop ejection apparatus of claim 7, wherein the oxide comprises silicon dioxide.

9. The drop ejection apparatus of claim 1, wherein the gas-supply region contains air or oxygen-enriched air.

10. The drop ejection apparatus of claim 1, wherein the gas-supply region is maintained at a pressure of from about 2 mm Hg to about 25 mm Hg higher than a pressure inside the conduit.

11. A method of jetting a material, the method comprising:
providing a drop ejector that includes
a jetting module configured to jet a material comprising a radiation-curable material,
a material supply module connected to the jetting module by a conduit, and
a gas permeable device attached to a wall of the conduit that includes a partition and a gas-delivery region, wherein the partition includes a non-wetting layer adjacent the gas-delivery region and a wetting layer opposite the non-wetting layer, and one or more passageways extending through the wetting and non-wetting layers;
conveying the material comprising the radiation-curable material through the conduit in such a manner that the material contacts the wetting layer of the gas permeable device; and
delivering gas to the gas-supply region.

12. A drop ejecting apparatus, comprising:
a jetting module configured to jet a material comprising a radiation-curable material; and
a material supply module that includes a conduit connecting the jetting module and a supply, wherein the conduit comprises a material having an oxygen permeability coefficient of greater than 20×10⁻¹¹ cm³·cm/cm²·s·cm Hg at standard temperature and pressure.

13. The drop ejecting apparatus of claim 12, wherein the conduit comprises a cross-linked polysiloxane.

14. The drop ejection apparatus of claim 12, wherein the oxygen permeability coefficient is greater than 1000×10⁻¹¹ cm³·cm/cm²·s·cm Hg.

15. The drop ejection apparatus of claim 12, wherein the oxygen permeability coefficient is greater than 25000×10⁻¹¹ cm³·cm/cm²·s·cm Hg.

16. A method of jetting a material, the method comprising:
providing a drop ejector that includes
a jetting module configured to jet a material comprising a radiation-curable material, and
a material supply module connected to the jetting module by a conduit, wherein the conduit comprises a material having an oxygen permeability coefficient of greater than 20×10⁻¹¹ cm³·cm/cm²·s·cmHg at standard temperature and pressure; and
conveying the material comprising the radiation-curable material through the conduit.

17. A method of jetting, the method comprising:
providing a drop ejector that includes
a jetting module configured to jet a material comprising a radiation-curable material, and
a material supply module housing the material and connected to the jetting module by a conduit; and
delivering gas bubbles to the material.

18. The method of claim 17, wherein the gas bubbles are delivered from a porous bubbler.

19. The method of claim 18, wherein the porous bubbler comprises sintered metal particles.

20. The method of claim 17, wherein the gas bubbles delivered have a diameter of less than about 100 micron.

21. The method of claim 17, wherein the gas bubbles delivered have a diameter of less than 10 micron.

22. The method of claim 17, wherein the gas bubbles delivered have a diameter of less than about 1 micron.

23. A package for holding a jetting material, comprising:
a hollow first container housing material comprising a radiation-curable material;
an operable seal disposed on the first container; and
a hollow second container disposed inside the sealed hollow first container, the hollow second container having an aperture defined in a wall of the second container.

24. The package of claim 23, wherein a diameter of each aperture is between about 0.001 inch to about 0.025 inch.
